(19) United States
(12) Patent Application Publication
(10) Pub. No.: US 2024/0294415 A1
(43) Pub. Date: Sep. 5, 2024

(54) BINDER JETTING PROCESS USING LIGHT CURING TECHNOLOGY

(71) Applicant: University of Tennessee Research Foundation, Knoxville, TN (US)

(72) Inventors: Dustin Blake Gilmer, Knoxville, TN (US); Alexander Kendall Stiles, Knoxville, TN (US)

(73) Assignee: University of Tennessee Research Foundation, Knoxville, TN (US)

(21) Appl. No.: 18/573,797

(22) PCT Filed: Jul. 25, 2022
(86) PCT No.: PCT/US2022/038230

§ 371 Date: Dec. 22, 2023

Related U.S. Application Data
(60) Provisional application No. 63/273,714, filed on Oct. 29, 2021.

(51) Int. Cl. C03B 19/01; B29C 64/165; B29C 64/209; B29C 64/218; B29C 64/245; B29K 33/00; B29K 105/00; B33Y 10/00; B33Y 30/00; B33Y 70/00

(52) U.S. Cl. CPC C03B 19/01; B29C 64/165; B29C 64/209; B29C 64/218; B29C 64/245; B33Y 10/00; B33Y 30/00; B33Y 70/00; B29K 2033/00; B29K 2105/0058

(57) ABSTRACT

A method of additive manufacturing is described wherein powder material is spread in a layer, contacted with a binding polymer and cured with light. Also described is a system for preparing additive manufactured objects such as molds, tools and composites.

### CROSS-REFERENCE TO RELATED APPLICATIONS

The presently disclosed subject matter claims the benefit of and priority to U.S. Provisional Patent Application Ser. No. 63/273,714, filed Oct. 29, 2021, the disclosure of which is incorporated herein by reference in its entirety.

### STATEMENT REGARDING FEDERALLY SPONSORED RESEARCH

This invention was made with government support under Grant No. DE-AC05-00OR22725 awarded by the Department of Energy. The government has certain rights in the invention.

### TECHNICAL FIELD

The presently disclosed subject matter relates, in some embodiments, to additive manufacturing methods, including methods of three-dimensional (3D) printing by binder jet, as well as products related to the methods.

### BACKGROUND

In the United States, only 36% of municipal solid waste (MSW) is currently recycled, leaving approximately 180 million tons of potential resources that are landfilled rather than being recycled, representing an untapped resource in the United States (US)/global economy. Some waste streams, such as glass, are infinitely recyclable but are often landfilled due to a lack of value-added end uses. In 2018, the US produced over 12 million tons of glass waste, and less than one-third of this was recycled.

Glass can be a raw material for additive manufacturing techniques, including binder jetting. Accordingly, there is an ongoing need for processes that can produce 3D printed components, particularly those made of recycled materials to reduce waste and lower cost.

### SUMMARY

In accordance with this disclosure, methods of additive manufacturing, such as binder jetting, are provided. In some embodiments, the method comprises: depositing the binding polymer onto a powder material; and photocuring the binding polymer and the powder material with light to produce an object. In some embodiments, the binding polymer comprises a resin and a photoinitiating system.

In some embodiments, the resin comprises a plurality of resins. In some embodiments, the resin comprises a component selected from the group consisting of an acrylate, a methacrylate, an epoxy, a thiol, an unsaturated polyester, a vinyl ester, an epoxy novolac, a polyurethane, a phenolic, a bis-maleimide, a polyimide, a silicone, and combinations thereof. In some embodiments, the resin comprises unsaturated polyesters. In some embodiments, the resin comprises vinyl esters. In some embodiments, the resin can include any combination of the above-listed materials, including combinations of several monomers and/or oligomers.

In some embodiments, the resin comprises an acrylate. In some embodiments, the acrylate comprises a plurality of acrylates. In some embodiments, the acrylate is selected from the group consisting of bisphenol A ethoxylate dimethacrylate (Bis-EMA) oligomer, hexanediol diacrylate (HDDA) monomer, trimethylolpropane triacrylate (TMPTA), tri- and tetra-acrylate esters of pentaerythritol (PETIA), tripropylene glycol diacrylate (TPGDA), isobornyl acrylate (IBOA), acrylic acrylate, amine modified bisphenol A epoxy diacrylate, bisphenol A epoxy diacrylate, bisphenol A glycidyl methacrylate (Bis-GMA), urethane dimethacrylate (UDMA), dipropylene glycol diacrylate (DPGDA), polyester triacrylate, polyester acrylate, polyester methacrylate, aliphatic urethane acrylate, epoxidized soya oil acrylate, bio-based aliphatic diacrylate, mercapto modified resins, polyether acrylate, triethylene glycol dimethacrylate (TEG-DMA), and combinations thereof. In some embodiments, the acrylate comprises bisphenol A ethoxylate dimethacrylate (Bis-EMA) oligomer. In some embodiments, the acrylate comprises hexanediol diacrylate (HDDA) monomer. In some embodiments, the resin comprises Bisphenol A ethoxylate dimethacrylate (Bis-EMA) oligomer and Hexanediol diacrylate (HDDA) monomer

In some embodiments, the photoinitiating system comprises a component that is selected from the group consisting of a phosphine oxide, an acyloximino ester, an anthraquinone, a benzoylformate ester, an alkylaminoacetophenone, a benzophenone, a thioxanthone, a benzil ketal, a dialkoxyacetophenone, a benzoin ether, a hydroxyacetophenone, a camphorquinone, a substituted a benzophenone, a titanocene, a dibenzylidene ketone, a ketocoumarins, a 1,2-diketone, a tertiary amine, an alpha-amino acid, a triphenylsulphonium salt, a diphenyliodonium salt, a dialkylphenacylsulphonium salt, a phenylbis(2,4,6-trimethylbenzoyl)phosphine oxide (BAPO), and combinations thereof. In some embodiments, the photoinitiating system comprises phenylbis (2,4,6-trimethylbenzoyl) phosphine oxide (BAPO).

In some embodiments, the powder material allows for light absorption by the binding polymer. In some embodiments, the powder material comprises a silica-based powder or a non-silica based powder. In some embodiments, the silica-based powder comprises a component selected from the group consisting of quartz, fused quartz, fumed silica, silica gel, opal, an aerogel, silica oxide, silicon (IV) oxide, silicon dioxide, crystalline silica, pure silica, silica sand, fiberglass, soda-lime silica-based powder, soda-lime glass powder, and combinations thereof. In some embodiments, the silica-based powder comprises soda-lime glass powder.

In some embodiments, the light comprises a wavelength ranging from about 200 nanometers (nm) to about 800 nm, optionally about 300 nm to 500 nm, further optionally about 315 nm to about 400 nm. In some embodiments, the wavelength can range from about 780 nm to about 2500 nm.

In some embodiments, the method further comprising adding an additional layer of the powder material and the binding polymer to a cured polymer powder object, e.g., composite.

In some embodiments, the additive manufacturing comprises binder jet additive manufacturing.

According to another aspect, there is provided an object prepared by a method of the presently disclosed subject matter.

According to another aspect, there is provided a mold or tool comprising the presently disclosed object.

According to another aspect, there is provided a system for additive manufacturing of an object. In some embodiments the system comprises a powder rolling stage configured to roll and spread a powder material. In some embodiments, the system comprises a printing stage configured to disperse a binding polymer from a print head orifice on to the powder material residing on the powder bed. In some embodiments, the system comprises a photocuring stage configured to cure the binding polymer and the powder material wherein a binding polymer and the powder material are processed into a desired composite.

In some embodiments, the powder rolling stage comprises a leveling roller configured to spread the powder material to a desired width and thickness. In some embodiments, the leveling roller is configured to push the powder material from powder feed piston to a build piston.

In some embodiments, the system further comprises a grinder configured to crush glass waste into the powder material.

In some embodiments, the system further comprises a sieve configured to separate out large powder material particles.

In some embodiments, the leveling roller is configured to level the powder material on a powder feed piston.

In some embodiments, the printing stage comprises a binding polymer reservoir for directing binding polymer to the print head orifice.

According to another aspect, there is provided a composite comprising a photocurable binding polymer and a powder material, wherein the binding polymer penetrates the powder material. In some embodiments, the powder material allows for light absorption by the binding polymer.

In some embodiments, the binding polymer comprises a resin and a photoinitiating system. In some embodiments, the powder material comprises a silica-based powder. In some embodiments, the binding polymer is cured by light.

According to another aspect, there is provided a cured composite prepared by photocuring the previously described composite.

According to another aspect, there is provided an object comprising the previously described composite.

Accordingly, it is an object of the presently disclosed subject matter to provide AM methods that can be used, for example, to prepare molds from powder material, including but not limited to powder material comprising silica, such as but not limited to a powder material derived from recycled glass. This and other objects are achieved in whole or in part by the presently disclosed subject matter.

An object of the presently disclosed subject matter having been stated above, other objects and advantages of the presently disclosed subject matter will become apparent to those of ordinary skill in the art after a study of the following description of the presently disclosed subject matter and non-limiting Examples and Figures.

### BRIEF DESCRIPTION OF THE FIGURES

The features and advantages of the present subject matter will be more readily understood from the following detailed description which should be read in conjunction with the accompanying drawings that are given merely by way of explanatory and non-limiting example, and in which:

FIG. 1 is a schematic drawing of a representative system that can be employed in accordance with a binder jet technology method in accordance with a representative embodiment of the presently disclosed subject matter.

FIG. 2 is a schematic drawing showing the recycling of glass via binder jetting in a representative method according to the presently disclosed subject matter.

### DETAILED DESCRIPTION

The presently disclosed subject matter pertains to additive manufacturing (AM) techniques, including 3D printing techniques like binder jet technology, which provide a novel value-added end use for glass waste, such as in the AM of tooling. By transforming the glass waste streams into raw materials for tooling, the US manufacturing sector can become a recycling mechanism that will also serve the US economy by producing high-value tooling at low cost. In some embodiments, binder jet technology (BJT) is employed, since any material that can be reduced to powder form can be incorporated into the process. Other AM methods can be employed, but limitations in utilization of recycled materials due to process constraints must be considered.

Other forms of additive manufacturing that can be employed include vat polymerization, material jetting, and material extrusion. Vat polymerization typically utilizes photopolymers and includes stereolithography (SLA), digital light processing (DLP), multiphoton lithography, and continuous digital light processing (cDLP). Lower viscosity resins are preferred to allow rapid resin flow into this small gap. Typical vat polymerization resins have a viscosity ranging from 0.2-10 Pa-s at low shear, as high viscosities can limit resin flow and lead to bubble formation, restricting print speeds.

Material extrusion methods include conventional thermoplastic printing methods such as fused deposition modeling (FDM), and broader printing methods such as direct ink writing (DIW) encompass thermosets, hydrogels, and low melt temperature metals. Dynamic viscosity is a consideration for DIW inks to create stable printed beads, and thixotropic agents such as fumed silica and nanoclay can improve shear-thinning behavior. While thermosetting inks must be capable of supporting the weight of multiple layers in an uncured state, UV-cured inks undergo rapid crosslinking and achieve gelation before the addition of new layers. UV cured inks do not have the same stability requirements as other thermosetting inks, but ink stability improves final part resolution. To enhance part resolution, improve overhangs and reduce cure-induced shrinkage and warp, photopolymer inks are often formulated with additives such as fumed silica, fiberglass, silica, carbon fiber, and carbon nanotubes.

Thus, the presently disclosed subject matter pertains to additive manufacturing (AM) techniques, including binder jetting techniques. Binder jetting is a 3D printing or AM method that selectively deposits a low viscosity liquid binder onto a bed of powder using a numerically controlled inkjet print head. Printed components are built with successive powder and binder layers, with the binder deposition pattern determining the final part geometry. Most binder jetting relies on a thermal curing step after printing to improve part strength, adding time and equipment cost to the printing process. In one aspect, the presently disclosed subject matter departs from conventional binder jetting by using light curing a photopolymer as the liquid binder. In some embodiments, an ultraviolet (UV) light source is positioned to expose each successive layer of a print with a dose of UV light sufficient to cure the polymer and achieve crosslinking bonds with the previous layer. By way of example, the light source can be positioned above the powder bed, on the print head, or on a gantry arm used to dispense powder. The addition of in-situ light (e.g., UV light) curing can reduce or even eliminate the need for thermal post-processing, thereby reducing print times. By removing the need to heat the build volume, the presently disclosed method also reduces equipment cost and facilitates larger print volumes over conventional binder jetting technology.

Accordingly, in some embodiments, the presently disclosed subject matter relates to methods and compositions for curing with light, such as UV curing, which provide in-situ curing in binder jet additive manufacturing (BJAM). In some embodiments, the presently disclosed method utilizes commercial photopolymers and initiators to provide a photoinitiating system to function as the binding medium with commercially available light sources (e.g., UV light sources) to initiate cross-linking and polymerization of the binder. Parts produced by this process can be either partially or fully cured using only light (e.g., UV radiation) or a combination of light (e.g., UV radiation) and heating.

In some embodiments, the presently disclosed subject method involves the utilization of powder feedstocks other than gypsum and/or cellulose powder, such as silica sand, quartz, and/or recycled glass; unique photopolymer formulations; light (such as but not limited to LED-based UV lamps), and/or production of 3D printed parts for larger-scale applications that can, in some embodiments, be provided in conjunction with a printer unlike anything currently available commercially. In some embodiments, the presently disclosed subject matter relates to recycling glass for use in 3D printing, including binder jetting.

### I. Definitions

While the following terms are believed to be well-understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a,” “an,” and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising,” which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

Unless otherwise indicated, all numbers expressing quantities of time, temperature, light output, atomic (at) or mole (mol) percentage (%), and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value is meant to encompass variations of in one example ±20% or ±10%, in another example ±5%, in another example ±1%, and in still another example ±0.1% from the specified amount, as such variations are appropriate to perform the disclosed methods.

Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

As used herein, a “monomer” refers to a molecule that can undergo polymerization, thereby contributing constitutional units, i.e., an atom or group of atoms, to the essential structure of a macromolecule.

As used herein, a “macromolecule” refers to a molecule of high relative molecular mass, the structure of which comprises the multiple repetition of units derived from molecules of low relative molecular mass, e.g., monomers and/or oligomers.

An “oligomer” refers to a molecule of intermediate relative molecular mass, the structure of which comprises a small plurality (e.g., 2, 3, 4, 5, 6, 7, 8, 9, or 10) of repetitive units derived from molecules of lower relative molecular mass.

A “polymer” refers to a substance comprising macromolecules. In some embodiments, the term “polymer” can include both oligomeric molecules and molecules with larger numbers (e.g., >10, >20, >50, >100) of repetitive units. In some embodiments, “polymer” refers to macromolecules with at least 10 repetitive units.

A “copolymer” refers to a polymer derived from more than one species of monomer.

As used herein, the term “silica” refers to silicon dioxide, an oxide of silicon with the chemical formula of SiO₂. Silica is the major constituent of sand. Notable examples of silica include fused quartz, fumed silica, silica gel, opal and aerogels. Silica is the primary ingredient in the production of most glass.

The terms “thermoset” and “thermosetting” can refer to a polymer that is irreversibly formed when polymer precursors (e.g., monomers and/or oligomers) react with one another when exposed to heat, suitable radiation (e.g., visible or ultraviolet light (UV)), and/or suitable chemical conditions (e.g., the addition of a chemical polymerization initiator or catalyst (e.g., a peroxide) and/or exposure to suitable pH conditions (such as brought about by the addition of an acid or base)). In contrast, a thermoplastic polymer is a polymer that softens and/or can be molded above a certain temperature but is solid below that temperature.

The terms “powder material(s)” and “powdered material(s)” are used herein interchangeably. The terms may also refer to heterogenous powder materials wherein the powder material comprises more than one ingredient or homogenous powder materials wherein the powder material comprises a single ingredient. Furthermore, the terms refer to a dry bulk solid comprising many very fine particles or granules that may flow freely when shaken, tiled, rolled or pushed. In some embodiments, the powder material comprises a particle size of about 1000 microns (μm) to about 50 μm. In some embodiments, the powder material comprises a particle size of about 900 μm to about 100 μm. In some embodiments, the powder material comprises a particle size of about 800 μm to about 200 μm. In some embodiments, the powder material comprises a particle size of about 700 μm to about 300 μm. In some embodiments, the powder material comprises a particle size of about 600 μm to about 400 μm. In some embodiments, the powder material comprises a particle size of about 500 μm. In some embodiments, the powder material comprises a particle size of about 300 μm. In some embodiments, the powder material comprises a plurality of particle sizes. In some embodiments, powder material comprises a coated powder material wherein the coated powder material affects flow, dispersion or adhesion to the binder polymer. Representative coatings are described elsewhere herein.

As used herein, the terms “disperse,” “dispersing” and “disperses” are used interchangeably. These terms refer to distributing, spraying, or extruding a material such as a liquid or binding polymer onto or over another material such as a powder material.

As used herein, the term “object” refers to a composite, mold, die, tool or any item created by the additive manufacturing process. In some embodiments, the term refers to an object comprising a composite as disclosed herein, e.g., a mold, die, or tool comprising the composite. In some embodiments, the term refers to architectural fixtures. In some embodiments, architectural fixtures refer to counter tops or building materials. In some embodiments, the term refers to household fixtures. In some embodiments, household fixtures include but are not limited to sinks or tubs.

As used herein, the term “additive manufacturing” refers to a process of creating an object by building it one layer at a time. In some embodiments, additive manufacturing comprises three-dimensional (3D) printing. In some embodiments, additive manufacturing comprises binder jetting or binder jetting additive manufacturing. In some embodiments, 3D printing comprises binder jetting or binder jet additive manufacturing.

As used herein, the term “print,” “printed” or “printing” refers to creating an object or 3D object by depositing of materials in layers.

As used herein in discussing the presently disclosed subject matter, the terms “photocure,” “photocurable,” “curable,” “cured” and “cure” are used generally interchangeably and refer to the physical process that produces the toughening or hardening of a binding polymer, such as by cross-linking of polymer chains, by the use of light, radiation or electromagnetic waves to cause the toughening or hardening process, and to a binding polymer amenable to being toughened or hardened by the physical process. In some embodiments, the curing reaction is generally irreversible and results in the conversion of the polymer material from a liquid into a solid. In some embodiments, the binding polymer is cured. In some embodiments, the resin is cured. In some embodiments, the resin and photoinitiating system are cured. In some embodiments, the resin, the photoinitiating system and the reactive diluent are cured. In some embodiments, the binding polymer penetrated powder material is cured. As used herein, the term “depowder” or “depowdering” refers to removing loose powder from the cured polymer powder composite.

As used herein, the term “photoinitiating system” refers to a reactant, or combination of reactants, that absorb light and produce initiating species such as free radicals, cations, acids, and/or bases.

The terms “silica powder” or “silica-based powder” are used herein interchangeably. The terms may refer to a homogenous silica powder that comprises a single type of silica particle such as of quartz, fused quartz, fumed silica, silica gel, opal, an aerogel, silica oxide, silicon (IV) oxide, silicon dioxide, crystalline silica, pure silica, silica sand, fiberglass, soda-lime silica-based powder and soda-lime glass powder. The terms may also refer to a heterogenous silica powder that comprises more than one of the previously listed types of silica particle. The terms may also refer to a heterogenous silica powder that comprises at least one type of silica particle and at least one non-silica particle component. The silica-based powder may refer to any sand with some silica content. In some embodiments, the silica-based powder comprises the capability to transmit light.

The terms “transmission of light,” “light transmissible” and “transmit light” are used herein interchangeably. The terms may refer to light passing through the individual particles found in the powder material, such as the individual particles found in the silica-based powder, and individual particles found in the non-silica based powder material. The terms may also refer to light passing through the spaces between the particles of the powder material, such as the silica-based powder or the non-silica based powder material. The terms may also refer to a characteristic of the powder material where light can pass though the particles of the powder material or through the spaces between the particles of the powder material.

The terms “light absorption,” and “absorb light” are used herein interchangeably. The terms may refer to matter, such as the binding polymer, including the photoinitiating system of the binding polymer, capturing electromagnetic radiation or photon energy and converting that radiation to internal energy.

The term “up-conversion” used herein refers to two or more incident photons of relatively low energy are absorbed and converted into one emitted photon with higher energy.

The terms “dark cure” and “dark cure reaction” are used herein interchangeably. The terms may refer to a binding polymer chemistry that has the ability to cure in regions that are not directly exposed to the irradiated light. In some embodiments, the terms may refer to shadow curing.

The term “onto” as used herein refers to when the binding polymer contacts the powder material. The term may also refer to when the binding polymer is deposited on and/or sprayed on the powder material, and/or the binding polymer penetrates the powder material to any degree.

### II. General Considerations

Binder jet technology (BJT) or binder jetting utilizes a unique layer-by-layer polymer binding process to print powders. BJT can allow for the rapid manufacturing of complex three-dimensional geometries at significantly higher throughput compared with directed-energy binding methods and forms parts out of powder material that previously were not possible to shape, such as ceramics. An advantage of BJT is the utilization of selective ink jetting to deliver a binding polymer onto layers of powder to bind the powder material together. The process typically forms a porous preform (i.e., a green part) after curing, typically at elevated temperature. The green part is then usually post-processed in various ways, including sintering or polymer infiltration, to produce dense material with higher mechanical strength. Moreover, BJT is advantageous for tooling purposes because it can produce components with isotropic properties at short lead times. Also, in BJT, powder material is spread into layers, and a binding agent is deposited selectively onto each layer by an inkjet print head to form parts. A difference between binder jetting and other additive manufacturing (AM) processes its ability to produce large volumes of parts with high throughput while still maintaining high resolution (˜200 microns, 100 L per hour). Moreover, BJT is advantageous for tooling purposes because it can produce components with isotropic properties at short lead times. In some embodiments of the presently disclosed subject matter, the use of recycled glass as a feedstock for BJT can yield high throughput, low lead time, and low-cost tooling, while also creating a path for reducing carbon intensity and energy use in manufacturing and reclaiming a land-intensive waste stream. In some embodiments, the feedstock comprises a powder material. In some embodiments, the feed stock comprises a combination of powder materials. In some embodiments, the feed stock comprises a powder material that allows for light absorption by the binding polymer, including the photoinitiating system of the binding polymer. In some embodiments, the feed stock comprises any powder material or combination of powder materials that allow light transmission. In some embodiments, the powder material comprises a silica-based material or a non-silica based material.

In a typical BJT process, powder is bound together with a thermoplastic or thermosetting binder, which requires secondary processing to achieve full strength. After printing, the entire powder bed is removed from the printer for oven curing. After curing, the part is removed from the oven in its green state and depowdered/removed from the loose powder. In the case of metal powder parts, it is then placed into a high temperature sintering furnace, where it is sintered either to full density or infiltrated with a secondary material. Binder jetting of silica sand has been studied in BJT by companies such as The ExOne Company and Voxeljet for the formation of sand cores used in metal casting. Recently, Freshmade3D innovated on this technology to form tooling by infiltrating the porous sand molds with an epoxy to strengthen the molds. This allows the molds to be utilized in tooling applications and for BJT to produce strong tooling for use in a variety of applications such as vacuum forming, composite tooling, compression molding, hydro forming, and sheet metal stamping. One downside of the current state of the art in BJT is the energy consumption due to the oven curing step. During this step, the oven is usually heated to 200° C., with typical energy consumption of a 60 L oven being approximately 6 kilowatts (kW) per hour. If sintering is required, the energy use consumption is much higher.

Instead of using the common thermoplastic or thermosetting binder systems currently utilized in binder jetting, in some embodiments, the presently disclosed methods utilize a binding polymer formulated to react or harden when exposed to light, in conjunction with a light emitting diode (LED) UV light source. This binding method greatly reduces the energy consumption of the process, with curing lamps generally consuming less than about 50 watts (W) of power. The binder tensile strength has already been demonstrated to exceed 70 MPa without any thermal post cure, which means that the presently disclosed method can eliminate the oven curing step entirely.

While conventional BJT processes are limited to producing parts small enough to fit in a curing oven, the presently disclosed light (e.g., UV) binding BJT method removes this volumetric constraint, allowing for potentially limitless part size. In addition, the high strength of the present light (e.g., UV) curing polymer system provides high strength without the need for epoxy infiltration. By eliminating both oven curing and infiltration steps, the presently disclosed subject matter increases throughput while maintaining the high mechanical properties required of tooling.

In regions where glass is recycled, it is often crushed into a gravel-like form known as cullet that is then fed back into the glass forming process. However, due to the high cost of transporting waste glass from collection points to processing facilities, most glass waste generated farther than about 300 miles from a processing facility is landfilled. Glass binder jet printer micro factories could be located in areas closer to collection points across the US near manufacturing centers, filling a gap in the current glass recycling infrastructure and increasing the percentage of glass recycled in the US by converting glass into high value tooling.

In some embodiments, the presently disclosed technology for AM, such as 3D-printing (including BJT) of advanced photo-polymer recycled glass composites, is capable of printing a large variety of products ranging from architectural applications, such as building facades, to consumer products. One particular application for the presently disclosed subject matter is advanced tooling. Tooling is the process of designing and engineering dies and molds that are used to manufacture parts or components and is an important element for producing components ranging from airplane wings to refrigerators. The entire globe relies on tooling to create products, and this is reflected in the fact that the global market for molds and dies in 2018 was $200.8 billion dollars and it is likely to reach $368.5 billion by 2026. This market has been steadily growing but in the U.S. the mold and die industry has been steadily declining with a decrease of 36% in mold manufacturing establishments in the country. This is compounded by the fact that the majority of die and mold manufacturers are small and medium size businesses in the U.S. and struggle to compete with overseas corporations. The decline in mold manufacturing establishments has severally affected the supply chain in many industries making it more difficult to source molds and dies. A specific example of this is the fact that in some cases it takes over a year for automotive companies to source a mold over 46 inches. This increases down time and costs for many manufacturers and affects companies downstream which utilize the molds and dies to create components ranging from fridges to automotive components. Utilizing AM for the manufacturing of molds and dies represents a significant opportunity to reduce lead times and costs. The decline in mold manufacturers also represents an opportunity to break into the underserved market.

The current market for composite tooling contains AM processes such as large-scale polymer extrusion offered by Cincinnati Inc. as the Big Area Additive Manufacturing (BAAM) system and Ingersoll Machine Tools, Inc.'s Wide and High Additive Manufacturing (WHAM), small scale polymer systems for limited applications, and Powder Bed Fusion (PBF) Direct Energy Deposition (DED) for metallic molds. BJT has recently started to penetrate into the tooling market because it can produce components with isotropic properties at high temperatures in short lead times. This address a pain point of large-scale polymer AM which exhibits anisotropy, making it difficult to utilize in applications where thermal energy is applied to parts.

In some embodiments, the presently disclosed BJAM method differentiates itself from other BJT methods through the use of a photocuring binding polymer system which imparts high heat resistance for autoclave tooling applications and the use of recycled glass material as the powder feedstock. The utilization of recycled glass allows for sourcing of local materials and lower material costs, making it lower cost than other tooling options and AM processes.

### III. Representative Embodiments

### III. A. Methods and Composites

In some embodiments, the presently disclosed subject matter provides an object, which can be a composite, mold, die, tool or any item created by the additive manufacturing process. In some embodiments, an object comprises a composite as disclosed herein, e.g., a mold, die, or tool comprising the composite. In some embodiments, the composite comprises a binding polymer. In some embodiments, the composite comprises a powder material that allows for light absorption by the binding polymer. In some embodiments, the powder material comprises the capability to transmit light. In some embodiments, the binding polymer is deposited onto the powder material. In some embodiments, the binding polymer comprises a resin and a photoinitiating system. In some embodiments, the powder material comprises a silica-based powder. In some embodiments, the composite is photocurable or photocured. In some embodiments, a cured composite prepared by photocuring a composite of the presently disclosed subject matter is provided. In some embodiments, the binding polymer is photocurable or photocured. In some embodiments, the resin and the photoinitiating system are cured by light. In some embodiments, the binding polymer is cured by light. In some embodiments, components of the composite are further described below.

In some embodiments, the presently disclosed subject matter provides a method of additive manufacturing of an object. In some embodiments, the additive manufacturing comprises three-dimensional (3D) printing. In some embodiments, the additive manufacturing comprises binder jet additive manufacturing (BJAM). In some embodiments, the additive manufacturing comprises binder jet technology (BJT). In some embodiments the method employs an additive manufacturing system and comprises photocuring a binding polymer and a powder material with light, such as when the binding polymer penetrated powder material is cured. In some embodiments, the binding polymer comprises a resin and a photoinitiating system. In some embodiments, the powder material comprises a combination of powder materials. In some embodiments, the powder material comprises a material that allows for light absorption by the photoinitiating system. In some embodiments, the powder material comprises a material that allows light transmission. In some embodiments, the powder material comprises a silica-based powder and/or a non-silica based powder. In some embodiments, the method comprises photocuring the binding polymer and powder material with a light.

In some embodiments, the binding polymer, also referred to herein as a photopolymer or a binder, comprises a resin. In some embodiments, the resin comprises about 0.01 wt % to about 20 wt % of the binding polymer. In some embodiments, the resin comprises about 0.01 wt % to about 10 wt % of the binding polymer.

In some embodiments, the resin comprises an acrylate. In some embodiments, the resin comprises a methacrylate. In some embodiments the resin comprises an epoxy. In some embodiments, the resin comprises a thiol. In some embodiments, the resin comprises a component selected from the group consisting of unsaturated polyester resin, epoxy, vinyl ester, epoxy novolac, polyurethane, phenolic, bis-maleimide, polyimide, silicone, and combinations thereof. In some embodiments, the resin comprises a plurality of resins. In some embodiments, the resin comprises unsaturated polyesters. In some embodiments, the resin comprises vinyl esters. In some embodiments, the resin can include combinations of the above-listed materials, including combinations of several monomers and/or oligomers.

In some embodiments, the resin comprises a material selected from the group consisting of a bisphenol A ethoxylate dimethacrylate (Bis-EMA) oligomer, a hexanediol diacrylate (HDDA) monomer, a trimethylolpropane triacrylate (TMPTA), a tri- and tetra-acrylate ester of pentaerythritol (PETIA), a tripropylene glycol diacrylate (TPGDA), an isobornyl acrylate (IBOA) an acrylic acrylate, an amine modified bisphenol A epoxy diacrylate, a bisphenol A epoxy diacrylate, a bisphenol A glycidyl methacrylate (Bis-GMA), an urethane dimethacrylate (UDMA), a dipropylene glycol diacrylate (DPGDA), a polyester triacrylate, a polyester acrylate, a polyester methacrylate, an aliphatic urethane acrylate, an epoxidized soya oil acrylate, a bio-based aliphatic diacrylate, a mercapto modified resin, polyether acrylate, triethylene glycol dimethacrylate (TEG-DMA), and combinations thereof. In some embodiments, the resin comprises a bisphenol A ethoxylate dimethacrylate (Bis-EMA) oligomer. In some embodiments, the resin comprises a hexanediol diacrylate (HDDA) monomer. In some embodiments, the plurality of resins comprises a bisphenol A ethoxylate dimethacrylate (Bis-EMA) oligomer and a hexanediol diacrylate (HDDA) monomer. In some embodiments the resin comprises at least 50% by weight of an oligomer. In some embodiments, the resin comprises at most 50% by weight of a monomer. In some embodiments, the resin comprises a combination of oligomers and monomers.

In some embodiments, oligomers and monomers, combinations thereof, and amounts thereof, are selected for the resin based on desired properties for the binding polymer and/or for an object to prepared. In some embodiments, the properties are selected from the group consisting of viscosity, strength, stiffness, wear resistance, char yield, optical properties and thermal stability, and combinations thereof.

In some embodiments, the binder further comprises a solvent. In some embodiments, the solvent comprises an aqueous solvent. In some embodiments, the aqueous solvent comprises water. In some embodiments, the aqueous solvent further comprises an alcohol. In some embodiments, the alcohol is selected from the group consisting of ethanol, methanol, butanol, propanol, isopropanol, and combinations thereof.

In some embodiments, the solvent comprises a non-aqueous solvent. In some embodiments, the non-aqueous solvent is selected from the group consisting of liquid ammonia, liquid sulfur dioxide, sulfuryl chloride and sulfuryl chloride fluoride, phosphoryl chloride, dinitrogen tetroxide, antimony trichloride, bromine pentafluoride, hydrogen fluoride, pure sulfuric acid and other inorganic acids, toluene, xylene, methyl ethyl ketone and acetone, and combinations thereof.

Binder viscosity and surface tension may be achieved without any additional components. In some embodiments, the binder is devoid of a solvent.

In some embodiments, the binding polymer comprises at least one solvent. In some embodiments, the at least one solvent comprises at least one diluent. In some embodiments, the at least one diluent is present to reduces the binder viscosity. In some embodiments, the at least one diluent comprises a reactive diluent. In some embodiments, the reactive diluent is configured to reduce viscosity and participating in the curing reaction. In some embodiments, the reactive diluent is styrene or other suitable vinyl derivatives of benzene or (meth)acrylates as would be apparent to one of ordinary skill in the art upon a review of the instant disclosure.

In some embodiments, the at least one diluent comprises a non-reactive diluent. In some embodiments, non-reactive diluents, as would be apparent one of ordinary skill in the art upon a review of the instant disclosure, do not participate in the curing reaction and are removed after printing (e.g., with an oven post cure).

In some embodiments, the non-reactive diluent comprises isopropyl alcohol or other suitable alcohol as would be apparent to one of ordinary skill in the art upon a review of the instant disclosure. In some embodiments the non-reactive diluent is selected from the group consisting of water, toluene, methyl ethyl ketone, acetone, and combinations thereof.

In some embodiments, the resin comprises an epoxy. Epoxies can be utilized with cationic-curing systems, and hybrid cationic/free-radical curing systems can be employed with a combination of acrylates and epoxies. In cationic-curing systems, light, such as UV energy, generates a protonic acid to initiate a ring opening of epoxy resins. In general, cationic-curing chemistries have slower reactions than free-radical systems, but hybrid cationic/free-radical chemistries can reduce this reaction time. In these hybrid systems, the cationic- and free-radical-curing components (e.g., epoxy and acrylate) should be compatible and cure at similar rates to avoid phase separation.

Thermal initiators and other latent species can also be incorporated into binding polymers (e.g., resin and photoinitiating system), taking advantage of the exothermic polymerization reaction to spur a photoinduced thermal reaction. Light can be used as a method of directly heating the polymer surface to trigger a frontal polymerization reaction. Additives such as dyes, nanoparticles, and/or up-conversion particles can also be incorporated that absorb light and convert it into either heat or light wavelengths that can trigger further reaction in the binding polymers

Chemistries can also be incorporated that utilize the reversible addition-fragmentation chain transfer (RAFT) process. The RAFT process generally involves the addition of a thiocarbonylthio compound to a free-radical system (e.g., acrylates), which controls the reaction such that all of the polymer chains grow at the same rate. This approach has been shown to yield a narrower molecular weight distribution and glass transition region while also improving monomer conversion. The RAFT approach can be employed in a wide variety of applications in photocuring including visible-light curing in 3D printing applications and in near infrared irradiation.

Instead of using the common thermoplastic or thermosetting binder systems in some embodiments, the presently disclosed subject matter utilizes a photocuring system employing light. In some embodiments the photocuring system is an ultraviolet (UV) curing polymer system, such as an UV curing polymer system in conjunction with an LED, to enable printing of exceptionally strong parts in-situ. The chemistry of photocuring systems has not been previously studied with regard to the formation of strong thermally resistant parts for use in final applications. When using photopolymers, the light curing reaction (e.g., UV curing reaction) can form a solid polymer network around the powder particles, trapping them inside of a polymer matrix which imparts strength unto the green part. Many monomers and oligomers typically used in photopolymer formulations can be suitable candidates for use in light (e.g., UV)-assisted BJAM. These include triethylene glycol dimethacrylate (TEGDMA), bisphenol A-glycidyl methacrylate (BisGMA), ethoxylated bisphenol A dimethacrylate (Bis-EMA) and hexanediol diacrylate (HDDA). These monomers and oligomers can be formulated with photoinitiating systems for free-radical curing, cationic curing, or a hybrid of curing mechanisms. In some embodiments, the presently disclosed subject matter can utilize a photopolymer binder comprising one or more UV curing polymers, oligomers and/or monomers with acrylate, methacrylate, or epoxide functionality, combined with a reactive diluent and initiator chemistry. In some embodiments, the initiator can operate via a free radical or Lewis acid mechanism, or a combination of the two. In some embodiments, the initiation comprises a UV or visible light source emitting in the 300 to 500 nm range. In some embodiments, the photoinitiating system comprises thermal initiators as hybrid chemistry, such as those disclosed herein above.

The choice of polymer, oligomer, or monomer can affect the rheological properties of the fluid, which will have an effect on how the binder can be delivered with ink-jet processes having specific rheological constraints described by the Webers Number and the Reynolds number which give a guideline of the printability of a fluid utilizing inkjet technology. The formulation chosen can also have an effect on the properties of the final part, such as strength and resistance to thermal degradation. Due to the ability to tune the formulation properties depending on the polymer, oligomer, or monomer, it is possible to tune the part properties to the chosen application. In addition, each powder material exhibits characteristics that make it useful for varying applications.

Various combinations of polymers, oligomers, and monomers with recycled glass can be provided to tune the properties for key application areas, such as tooling and architecture. Key characteristics for tooling include the coefficient of Thermal Expansion (CTE), stiffness, thermal conductivity, and heat capacity, which will be benchmarked against industry standards, such as aluminum and tooling board. To scale the technology, the presently disclosed process will be adapted for a large-scale AM approach to form parts that can be utilized by industry in sectors such as aerospace and automotive. This is one of the inherent advantages of the developed technology, since, as described above, conventional BJT processes are limited to producing parts small enough to fit in a curing oven to strengthen the green preforms. The UV binding method removes this volumetric constraint, leading to potentially limitless part size.

Binding polymers employed in accordance with the presently disclosed subject matter, including binders used in BJAM, desirably have particular rheological characteristics to eject from the print head orifice and form a stable droplet. The Ohnesorge number (Oh) (Eq.1) is utilized to determine if the rheological characteristics of the ink are in the proper range for printing. The Ohnesorge number is a dimensionless number that describes the viscous forces with respect to surface tension forces. The Ohnesorge number comprises of two dimensionless numbers, the Weber number We(Eq.2)(i.e., fluid's inertia compared to its surface tension) and the Reynolds number Re(Eq.3)(i.e., fluid's inertial forces compared to viscous forces within a fluid), where μ is dynamic viscosity, ρ is the density, ν is the flow speed, γ is the surface tension of the binder, and D is the nozzle diameter of the print head. Fromm first identified the Ohnesorge number to characterize droplet formation. Fromm (1984). These numbers offer a guideline for a fluid's printability utilizing inkjet. Fromm (1984); Derby (2010); Van Hoeve et al. (2010). Fromm used the parameter Z=1/Oh to characterize the ability to form droplets and proposed that Z>2 formed stable droplets. Reis and Derby used numerical simulations and presented a differing opinion on the droplet formation range based on Z number, proposing 10>Z>1 for stable droplet formation. Derby (2010). The viscosity and surface tension have the

$$Oh = \frac{\sqrt{WE}}{Re} = \frac{μ}{\sqrt{γρ D}} \qquad ( 1 )$$

$$We = \frac{ρ {v}^{2} D}{γ} \qquad ( 2 )$$

$$Re = \frac{ρ vD}{u} \qquad ( 3 )$$

largest effect on the printability of the binder and are the most important when formulating a binder fluid. Friederich et al. (2013); Hon et al. (2008).

In some embodiments, the binding polymer comprises about 1% by weight to about 60% by weight of the object. In some embodiments, the powder material comprises about 40% by weight to about 99% by weight of the object.

In some embodiments of the presently disclosed subject matter, the binding polymer comprises a viscosity of about 1 millipascal-seconds (mPa*s) to about 100 mPa*s. In some embodiments, the binder comprises a viscosity of about 10 mPa*s to about 90 mPa*s. In some embodiments, the binder comprises a viscosity of about 20 mPa*s to about 80 mPa*s. In some embodiments, the binder comprises a viscosity of about 30 mPa*s to about 70 mPa*s. In some embodiments, the binder comprises a viscosity of about 40 mPa*s to about 60 mPa*s. In some embodiments, the binder comprises a viscosity of about 10 mPa*s. In some embodiments, mPa*s and centipoise (cp) are used interchangeably. In some embodiments, the binder comprises a viscosity of less than 300 cp.

In some embodiments, the binder comprises a surface tension. In some embodiments, the binder comprises a surface tension of about 20 millinewton per meter (mN*m⁻¹) to about 100 mN*m⁻¹. In some embodiments, the binder comprises a surface tension of about 40 mN*m⁻¹ to about 80 mN*m⁻¹. In some embodiments, the binder comprises a surface tension of about 50 mN*m⁻¹ to about 60 mN*m⁻¹. In some embodiments, the binder comprises a surface tension of about 27 mN*m⁻¹ to about 33 mN*m⁻¹. In some embodiments, the binder comprises a surface tension of about 30 mN*m⁻¹. In some embodiments, the binder has a tensile strength of at least 70 megapascals (MPa).

The binder's rheological characteristics are controllable depending on the chemical composition of the binder, which can be altered by adding components such as solvents, surfactants, humectants, wetting agents, viscosity modifiers, and chelating agents to add functionality and improve printing capability. Jang et al. (2009); Fink (2014). Ink solution systems often comprise a buffering system to maintain the pH, a surfactant to lower the surface tension, a humectant to inhibit desiccation, a biocide to prevent fungi and bacterial growth, a corrosion inhibitor to protect the metal portions, and/or an anti-foaming agent to counteract the foaming effect of many surfactants. Fink (2014); Leach et al. (2007). In some embodiments, the binder further comprises a modifier selected from the group comprising a solvent, a surfactant, a humectant, a viscosity modifier, a chelating agent, and combinations thereof.

The binder used in the BJAM process can play a role in determining geometric accuracy, powder removal capability, part performance, and the chemistry of the final part. In a typical conventional BJAM process, powder is bound together with a thermoplastic (In-Liquid) or thermosetting (In-Bed) binder, which then involves secondary processing to achieve high strengths.

In some embodiments, the binding polymer comprises a photoinitiating system. In some embodiments, the photoinitiating system is a molecule that creates reactive species (free radicals, cations, anions, acids, bases, etc.) when exposed to a light, such as ultraviolet (UV) or visible light. In some embodiments, the photoinitiating system causes a free radical curing reaction. In some embodiments, the photoinitiating system causes a cation curing reaction. In some embodiments, the photoinitiating system causes an anion curing reaction. In some embodiments, the photoinitiating system provides a dark cure reaction. In some embodiments, a top portion of the binding polymer or binding polymer penetrated powder absorbs light to cause a curing reaction. In some embodiments, “top portion” refers to the region of the binding polymer or binding polymer penetrated powder closest to the light source in a given layer of powder material and binding polymer to be cured. In some embodiments, a dark cure reaction is employed with silica-based powder material and/or a non-silica based powder material. In some embodiments, a whole portion of the binding polymer or binding polymer penetrated powder absorbs light to cause a curing reaction.

In some embodiments, the photoinitiating system comprises about 0.01 wt % to about 10 wt % of the binding polymer. In some embodiments, the photoinitiating system comprises about 0.1 wt % to about 2 wt % of the binding polymer.

In some embodiments, the photoinitiating system is selected from the group consisting of a phosphine oxide, an acyloximino ester, an anthraquinone, a benzoylformate ester, an alkylaminoacetophenone, a benzophenone, a thioxanthone, a benzil ketal, a dialkoxyacetophenone, a benzoin ether, a hydroxyacetophenone, a camphorquinone, a substituted a benzophenone, a titanocene, a dibenzylidene ketone, a ketocoumarins, a 1,2-diketone, a tertiary amine, an alpha-amino acid, a triphenylsulphonium salt, a diphenyliodonium salt, a dialkylphenacylsulphonium salt, a phenylbis (2,4,6-trimethylbenzoyl) phosphine oxide (BAPO), and combinations thereof. In some embodiments, the photoinitiating system comprises a phenylbis (2,4,6-trimethylbenzoyl) phosphine oxide (BAPO).

In some embodiments, the binding polymer comprises a resin and a photoinitiating system. In some embodiments, the binding polymer comprises a plurality of resins and a photoinitiating system. In some embodiments, the binding polymer comprises a plurality of resins, a plurality of photoinitiating systems and at least one pigment. In some embodiments, the at least one pigment comprises at least one dye. In some embodiments, the binding polymer further comprises at least one solvent.

In some embodiments, the binding polymer comprises 80 parts bisphenol A ethoxylate dimethacrylate (Bis-EMA) oligomer; 20 parts hexanediol diacrylate (HDDA) monomer and 0.5 parts phenylbis (2,4,6-trimethylbenzoyl) phosphine oxide (BAPO).

In accordance with the presently disclosed subject matter, a powder material is employed. In some embodiments, the powder material comprises a material that allows for the binding polymer, including the photoinitiating system in the binding polymer, to absorb light. In some embodiments, the powder material comprises the capability to transmit light.

In some embodiments, the powder material comprises silica-based powder, such as a silica-based powder derived from glass, including recycled glass. In some embodiments, the silica-based powder comprises the capability to transmit light. In some embodiments, the powder material is crushed glass. In some embodiments, the powder material is ground glass. In some embodiments, the silica-based powder is selected from the group consisting of quartz, fused quartz, fumed silica, silica gel, opal, aerogels, silica, silica oxide, silicon(IV) oxide, silicon dioxide, crystalline silica, pure silica, silica sand, fiberglass, soda-lime silica powder, soda-lime glass powder, and combinations thereof. In some embodiments, the silica-based powder is soda-lime glass powder. In some embodiments, the silica-based powder comprises sand with silica-based powder.

In some embodiments, the powder material comprises a non-silica based powder. In some embodiments, the non-silica based powder allows for the binding polymer, including the photoinitiating system in the binding polymer, to absorb light. In some embodiments, the non-silica-based powder comprises the capability to transmit light. In some embodiments, the non-silica based powder is selected from a group consisting of a ceramic, a polymer, a fiber, and combinations thereof. In some embodiments, a ceramic can be selected from the group consisting of alumina, aluminum nitride, carbon, silicon carbide, tungsten carbide, tungsten carbide cobalt, synthetic sands, natural sands, and combinations thereof. In some embodiments, a polymer is selected from the group consisting of a virgin polymer, a recycled polymer, and combinations thereof. In some embodiments, a polymer comprises a virgin thermoplastic powder, a recycled thermoplastic powder, or combinations thereof, such as selected from the group consisting of a polycarbonate, a polylactic acid, a polymethyl methacrylate, a polyethylene terephthalate, a polyamide 12, a polyamide 11, a polyamide 6, a polyether ether ketone, a polyether ketone, a thermoplastic polyurethane, a polypropylene, a polybutylene terephthalate, a thermoplastic amide, a thermoplastic co-polyester, and combinations thereof. In some embodiments, a polymer comprises a virgin thermoset powder, a recycled thermoset powder, or combinations thereof, such as selected from the group consisting of a vinyl ester, a polyester, an epoxy, a polyurethane, a phenolic, and combinations thereof. Combinations of a virgin thermoplastic powder, a recycled thermoplastic powder, or combinations thereof and a virgin thermoset powder, a recycled thermoset powder, or combinations thereof, can also be employed. In some embodiments, the fiber can be a virgin or a recycled fiber, such as virgin or recycled fibers selected from the group consisting of a carbon fiber, a basalt fiber, a boron fiber, a para-aramid fiber, a polypropylene fiber, an ultra-high molecular weight polyethylene fiber, and combinations thereof. In some embodiments, the non-silica based powder comprises graphene. In some embodiments, the powder material comprises a composite material, such as a virgin or recycled composite material, such as a virgin or recycled composite material selected from the group consisting of silica, concrete, porcelain, and brick, and combinations thereof. By way of example and not limitation, such composite materials can be employed with a dark cure reaction as described elsewhere herein.

Glass is not only readily available as a waste stream, but also has desirable physical characteristics. The silica sand tooling currently produced by ExOne Corporation provides a tool with a low coefficient of Thermal Expansion (CTE). This is due to the low CTE of the silica sand which constitutes the majority of the part both in weight and volume percentage. Crushed glass has a similar chemical composition to silica sand and corresponding low CTE, which is important to many tooling applications, such as composite layups. In addition, the resulting composite of the presently disclosed subject matter (e.g., glass/UV polymer composite) provides a highly wear resistant surface, which will extend tooling life in comparison with other polymer-based AM tooling. The processability of the present combination of glass and binding polymer can be adjusted as necessary by tuning the binders and particles for the binder jetting process.

In some embodiments, the powder material comprises a layer of powder material configured to receive the binding polymer. In some embodiments, the layer of powder material comprises a thickness. In some embodiments, the layer of powder material comprises a thickness of about 1000 μm to about 50 μm. In some embodiments, the layer of powder material comprises a thickness of about 900 μm to about 100 μm. In some embodiments, the layer of powder material comprises a thickness of about 800 μm to about 200 μm. In some embodiments, the layer of powder material comprises a thickness of about 700 μm to about 300 μm. In some embodiments, the layer of powder material comprises a thickness of about 600 μm to about 400 μm. In some embodiments, the layer of powder material comprises a thickness of about twice the particle size of the powder material. In some embodiments, the layer of powder material comprises a thickness of about twice the size of the largest particle size of the powder material (e.g., if the largest particle size is 300 μm then the thickness of the layer of powder material is 600 μm).

In some embodiments, the method comprises depositing the binding polymer onto a powder material to provide a binding polymer penetrated powder. In some embodiments, depositing comprises contacting the binding polymer with the powder material. The binding polymer integrates with the powder material affixing the powder material together. In some embodiments, depositing comprises binder jetting the binding polymer onto a powder material to provide a binding polymer penetrated powder.

In some embodiments, the method comprises employing an additive or a modifier. In some embodiments, the additive or the modifier is incorporated into the binding polymer or powder material. In some embodiments, the additive or the modifier provides or improves flame retardance. In some embodiments, the additive or the modifier that provides or improves flame retardance comprises a halogen. In some embodiments, the additive or the modifier that provides improves flame retardance comprises an intumescent agent. In some embodiments, the additive or the modifier comprises a glass coating. In some embodiments the glass coating comprises a silane. In some embodiments, the glass coating is selected from the group consisting of a silane, epoxy, polyurethane, phenolic, (meth)acrylate, polyester, vinyl ester, and combinations thereof.

In some embodiments, the additive or modifier comprises a UV blocking agent. In some embodiments the UV blocking agent comprises one or more hindered amine light stabilizers (HALS). In some embodiments, the UV blocking agent comprises titanium dioxide.

In some embodiments, the method comprises photocuring the binding polymer penetrated powder with a light. In some embodiments, the cured binding polymer penetrated powder comprises a cured polymer powder object, e.g., composite. In some embodiments, the light comprises visible light. In some embodiments, the light comprises UV light. In some embodiments the light comprises a wavelength of about 200 nanometers (nm) to about 800 nm. In some embodiments, the light comprises a wavelength of about 300 nm to about 500 nm. In some embodiments, the light comprises a wavelength of 315 nm to about 400 nm. In some embodiments, the UV light comprises UVA light. In some embodiments, a UVA light emitting diode (LED) provides the light. In some embodiments, the UV light consumes less than 50 watts (W) of power. In some embodiments, the light comprises infrared light. In some embodiments, the light comprises near infrared light. In some embodiments, the light comprises a wavelength of 780 nm to 2500 nm.

In some embodiments, the light comprises electron beam irradiation. In some embodiments, the light comprises microwave irradiation.

In some embodiments, the light comprises a broad spectrum lamp. In some embodiments, the broad spectrum lamp is a mercury vapor lamp. In some embodiments, the broad spectrum lamp comprises a fluorescent lamp. In some embodiments, the light comprises multi-frequency LEDs. In some embodiments, the light comprises single-frequency lasers. In some embodiments, the light comprises solar light.

In some embodiments, the method further comprises depowdering the cured polymer powder object, e.g., composite.

In some embodiments, the method further comprises adding an additional layer or a plurality of additional layers of the powder material and the binding polymer to the cured polymer powder object, e.g., composite.

In some embodiments, the method further comprises dispersing the binding polymer by a print head orifice. In some embodiments, the print head orifice is a nozzle. In some embodiments, the nozzle comprises an ink jet nozzle. In some embodiments, the nozzle comprises a spray nozzle. In some embodiments, the nozzle comprises an injection nozzle.

In some embodiments, the presently disclosed subject matter relates to upcycling glass from waste streams. For example, the presently disclosed method can involve crushing and grinding the glass into powder form suitable for shaping via binder jetting.

### III. B. Systems

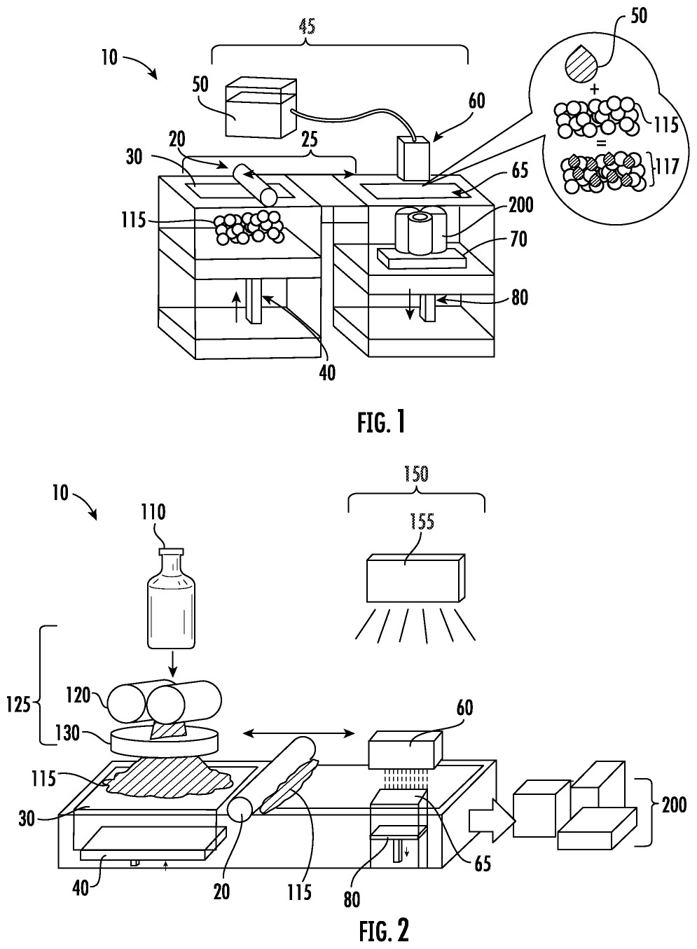

In some embodiments, the presently disclosed subject matter provides a system for carrying out a method as disclosed herein. Referring to FIGS. 1 and 2, in some embodiments, the presently disclosed subject matter provides a system 10 for additive manufacturing of an object 200. In some embodiments, the object may be a composite, tool, mold or other object as described herein. In some embodiments, the system 10 comprises a grinding stage 125, comprising a grinder 120 configured to grind glass waste 110 into a powder material 115. In some embodiments, the grinding stage 125 comprises a sieve 130 configured to separate large powder material particles and small powder material particles from the powder material 115. In some embodiments, the powder material 115 is collected in a powder feed reservoir 30 on a powder feed piston 40. In some embodiments, the powder feed piston 40 is configured to move the powder material 115 upward out of the powder feed reservoir 30.

In some embodiments, the system 10 comprises powder rolling stage 25, comprising a leveling roller 20 configured to spread and level the powder material 115. In some embodiments, the powder feed piston 40 is configured to move the powder material 115 upward to the leveling roller 20. In some embodiments, the leveling roller 20 pushes the powder material 115 from a powder feed piston 40 to a build piston 80. In some embodiments, the leveling roller 20 levels and spreads the powder material 115 to a desired thickness on the build piston 80.

In some embodiments, the system 10 comprises a printing stage 45, comprising a print head orifice 60 configured to disperse a binding polymer 50. In some embodiments, the print head orifice 60 disperses the binding polymer 50 onto the powder material 115 residing on a powder bed 70, resulting in a binding polymer penetrated powder 117. In some embodiments the powder bed 70 is configured on the build piston 80. In some embodiments, the powder bed 70 is a layer of powdered material 115 configured to receive binding polymer 50. In some embodiments, the print head orifice 60 is configured to move to disperse the binding polymer 50 in a desired pattern or shape onto the powder material 115 of the powder bed 70 achieving the binding polymer penetrated powder 117.

In some embodiments, the system 10 comprises a photocuring stage 150, wherein a light 155 can be emitted. In some embodiments, the light 155 is configured to photocure the binding polymer penetrated powder 117. The light can comprise any light at any wavelength as disclosed elsewhere herein.

In some embodiments, the build piston 80 is configured to maneuver into a build reservoir 65 to receive an additional layer of powder material 115, wherein the additional layer of powder material 115 is configured to receive binding polymer 50 dispersed from the print head orifice 60. In some embodiments, the system 10 repeats the layering of powder material 115 and binding polymer 50 to additively manufacture a photocured binding polymer penetrated powder that results in a shape of the object 200.

### REFERENCES

All references listed in the instant disclosure, including but not limited to all patents, patent applications and publications thereof, scientific journal articles, and database entries are incorporated herein by reference in their entireties to the extent that they supplement, explain, provide a background for, and/or teach methodology, techniques, and/or compositions employed herein. The discussion of the references is intended merely to summarize the assertions made by their authors. No admission is made that any reference (or a portion of any reference) is relevant prior art. Applicants reserve the right to challenge the accuracy and pertinence of any cited reference.
Fromm (1984) IBM J. Res. Dev. 28
Derby (2010), Annu. Rev. Mater. Res. 40: 395-414.
Van Hoeve et al. (2010) Breakup of diminutive Rayleigh jets https://arxiv.org/pdf/1011.0320.pdf
Friederich et al. (2013) J. Am. Ceram. Soc.
Hon et al. (2008) CIRP Ann.-Manuf. Technol. 57: 601-620.
Jang et al. (2009) Langmuir. 25: 2629-2635
Fink (2014) The Chemistry of Printing Inks and Their Electronics and Medical Applications.
Leach et al. (2007) The Printing Ink Manual. www.springer.com.
U.S. Pat. No. 11,254,617 B2 to Saito et al.

While the presently disclosed subject matter has been disclosed with reference to specific embodiments, it is apparent that other embodiments and variations of this presently disclosed subject matter can be devised by others skilled in the art without departing from the true spirit and scope of the presently disclosed subject matter.

It will be understood that various details of the presently disclosed subject matter can be changed without departing from the scope of the presently disclosed subject matter. Furthermore, the foregoing description is for the purpose of illustration only, and not for the purpose of limitation.

1. A method for additive manufacturing of an object, the method comprising:
depositing a binding polymer onto a powder material; and
photocuring the binding polymer and the powder material with light.

2. The method of claim 1, wherein the binding polymer comprises a resin and a photoinitiating system.

3. The method of claim 2, wherein the resin comprises a plurality of resins.

4. The method of claim 2, wherein the resin comprises a component selected from the group consisting of an acrylate, a methacrylate, an epoxy, a thiol, an unsaturated polyester, a vinyl ester, an epoxy novolac, a polyurethane, a phenolic, a bis-maleimide, a polyimide, a silicone, and combinations thereof.

5. The method of claim 2, wherein the resin comprises an acrylate.

6. The method of claim 2, wherein the resin comprises a plurality of acrylates.

7. The method of claim 5, wherein the acrylate is selected form the group consisting of bisphenol A ethoxylate dimethacrylate (Bis-EMA) oligomer, hexanediol diacrylate (HDDA) monomer, trimethylolpropane triacrylate (TMPTA), tri- and tetra-acrylate esters of pentaerythritol (PETIA), tripropylene glycol diacrylate (TPGDA), isobornyl acrylate (IBOA), acrylic acrylate, amine modified bisphenol A epoxy diacrylate, bisphenol A epoxy diacrylate, bisphenol A glycidyl methacrylate (Bis-GMA), urethane dimethacrylate (UDMA), dipropylene glycol diacrylate (DPGDA), polyester triacrylate, polyester acrylate, polyester methacrylate, aliphatic urethane acrylate, epoxidized soya oil acrylate, bio-based aliphatic diacrylate, mercapto modified resins, polyether acrylate, triethylene glycol dimethacrylate (TEG-DMA), and combinations thereof.

8. The method of claim 5, wherein the acrylate comprises bisphenol A ethoxylate dimethacrylate (Bis-EMA) oligomer.

9. The method of claim 5, wherein the acrylate comprises hexanediol diacrylate (HDDA) monomer.

10. The method of claim 2, wherein the resin comprises bisphenol A ethoxylate dimethacrylate (Bis-EMA) oligomer and hexanediol diacrylate (HDDA) monomer.

11. The method of claim 2, wherein the photoinitiating system comprises a component selected from the group consisting of a phosphine oxide, an acyloximino ester, an anthraquinone, a benzoylformate ester, an alkylaminoacetophenone, a benzophenone, a thioxanthone, a benzil ketal, a dialkoxyacetophenone, a benzoin ether, a hydroxyacetophenone, a camphorquinone, a substituted a benzophenone, a titanocene, a dibenzylidene ketone, a ketocoumarin, a 1,2-diketone, a tertiary amine, an alpha-amino acid, a triphenylsulphonium salt, a diphenyliodonium salt, a dialkylphenacylsulphonium salt, a phenylbis (2,4,6-trimethylbenzoyl) phosphine oxide (BAPO), and combinations thereof.

12. The method of claim 2, wherein the photoinitiating system comprises a phenylbis (2,4,6-trimethylbenzoyl) phosphine oxide (BAPO).

13. The method of claim 1, wherein the powder material allows for light absorption by the binding polymer.

14. The method of claim 1, wherein the powder material comprises a silica-based powder or a non-silica based powder.

15. The method of claim 14, wherein the silica-based powder comprises a component selected from the group consisting of quartz, fused quartz, fumed silica, silica gel, opal, an aerogel, silica oxide, silicon (IV) oxide, silicon dioxide, crystalline silica, pure silica, silica sand, fiberglass, soda-lime silica powder, soda-lime glass powder, and combinations thereof.

16. The method of claim 15, wherein the silica-based powder comprises soda-lime glass powder.

17. The method of claim 1, wherein the light comprises a wavelength ranging from about 200 nanometers (nm) to about 2,500 nm, optionally about 200 nm to about 800 nm, optionally about 300 nm to 500 nm, further optionally about 315 nm to about 400 nm, further optionally about 780 nm to 2,500 nm.

18. The method of claim 1, further comprising adding an additional layer of the powder material and the binding polymer to a cured polymer powder composite.

19. The method of claim 1, wherein the additive manufacturing comprises binder jet additive manufacturing.

20. An object prepared by a method of claim 1.

21. A mold or tool comprising the object of claim 20.

22. A system for additive manufacturing of an object, the system comprising:
(i) a powder rolling stage configured to roll and spread a powder material;
(ii) a printing stage configured to disperse a binding polymer from a print head orifice onto a powder material residing on a powder bed; and
(iii) a photocuring stage configured to cure a binding polymer and a powder material wherein a binding polymer and a powder material are processed into a desired object.

23. The system of claim 22, wherein the power rolling stage comprises a leveling roller configured to spread the powder material to a desired width and thickness.

24. The system of claim 23, wherein the leveling roller is configured to push the powder material from a powder feed piston to a build piston.

25. The system of claim 21, further comprising a grinder configured to crush glass waste into a powder material.

26. The system of claim 21, further comprising a sieve configured to separate out large powder material particles.

27. The system of claim 23, wherein the leveling roller is configured to level a powder material on a powder feed piston.

28. The system of claim 21, wherein the printing stage comprises a binding polymer reservoir for directing binding polymer to the print head orifice.

29. A composite comprising
(a) a photocurable binding polymer; and
(b) a powder material, wherein the binding polymer penetrates the powder material.

30. The composite of claim 29, wherein the powder material allows for light absorption by the binding polymer.

31. The composite of claim 29, wherein the binding polymer comprises a resin and a photoinitiating system.

32. The composite of claim 29, wherein the powder material comprises a silica-based powder.

33. The composite of claim 29, wherein the binding polymer is cured by light.

34. A cured composite prepared by photocuring a composite of claim 29.

35. An object comprising the composite of claim 29.

36. An object comprising the composite of claim 34.
